(19) United States
(12) Patent Application Publication
(10) Pub. No.: US 2016/0061855 A1
(43) Pub. Date: Mar. 3, 2016

(54) METHOD FOR THE COMBINED DETERMINATION OF A SPEED AND AN IMAGE TAKEN FROM A VEHICLE, AND APPARATUS SUITABLE THEREFOR

(71) Applicant: TRAJET GMBH, Braunschweig (DE)

(72) Inventor: Christian HELCK, BRAUNSCHWEIG (DE)

(73) Assignee: TRAJET GmbH

(21) Appl. No.: 14/784,142

(22) PCT Filed: Apr. 16, 2014
(86) PCT No.: PCT/EP2014/057759

§ 371 Date: Oct. 13, 2015

(30) Foreign Application Priority Data
Apr. 16, 2013 (DE) 10 2013 006 519.4

(51) Int. Cl. G01P 3/38; G06K 9/00; G06T 7/20; B60R 1/00; G01S 19/52; G01P 7/00

(52) U.S. Cl. CPC G01P 3/38; G01S 19/52; G01P 7/00; G06T 7/20; B60R 1/00; G06K 9/00791; G06T 2207/30252

(57) ABSTRACT

A method for the combined determination of a speed and an image recording from a moving vehicle is carried out with the following steps:
recording an image of a region in front of the vehicle by means of a video camera and storing it in a storage medium,
measuring the speed of the vehicle and storing it in a storage medium,
associating the values of the speed recorded at a particular point in time with images of the stored image recordings,
recording satellite-aided information from the Global Positioning System (GPS) for navigation devices in the vehicle,
determining the speed of the vehicle at a particular point in time from the recorded data of the GPS,
determining the acceleration and deceleration of the vehicle at a particular point in time by means of acceleration sensors,
determining the speed of the vehicle at a particular point in time from the values of the acceleration and deceleration,
determining and evaluating the deviation of the speed determination from the data of the GPS and from the values of the acceleration, and
in the event that the deviation of the speed determination does not exceed a pre-determined, possibly also variable, tolerance threshold, associating this speed determination with the image recording made at the same point in time, otherwise rejecting or suitably identifying the determined values and images.

The invention relates to a method for the combined determination of a speed and an image recording from a moving vehicle, comprising the following steps:
recording an image of a region in front of the vehicle by means of a video camera and storing it in a storage medium,
measuring the speed of the vehicle and storing it in a storage medium, and
associating the values of the speed recorded at a particular point in time with images of the stored image recordings.

The invention also relates to a device for carrying out this method.

The speed of a moving vehicle is of interest for several reasons. For example, the driver of the vehicle needs the information in order, for example in road traffic, to be able to estimate better the probable behaviour of his vehicle during steering movements and, in particular, also the braking distance and, furthermore, in order to comply with speed limits. Apart from the driver of the vehicle himself, the speed can also be of interest to other users, for example, in the automotive industry for the development of new engines and vehicles.

There are various possibilities for a user to determine the speed of a moving vehicle. Conventionally, for this purpose, the tachometer of the vehicle which makes use of the rotation count per unit time of the wheels of the vehicle, previously mechanically or, more recently, electronically, is read by the driver of the vehicle. If the circumference of the wheels is taken to be a constant and known, then from the rotation count per unit time, the movement speed of the vehicle can be calculated without difficulty. Such methods are sufficiently precise in daily road traffic in order to give the driver of a motor vehicle an overview of the current speed at which he is driving his vehicle.

There also exist improved methods for such cases in which a more precise measurement is desired, for example, in the development of new engines or for commercial uses. By means of rotation sensors and the measurement of the angular acceleration of a wheel of the motor vehicle, inaccuracies resulting inter alia from the changeable circumferential length of a motor vehicle wheel due to wear, temperature variations and the influences of pressure in the interior of the tyre can be readily compensated for. Methods of this type are described, for example, in WO 2007/125033 A1. Also described therein are evaluating devices and the possibility of communicating the relevant data to a stationary receiver. This is of great interest for commercial applications, particularly in the development departments of the automotive industry.

It has also previously been proposed, for determining the speed of the vehicle, to utilise satellite-aided navigation systems, particularly the Global Positioning System (GPS). A procedure of this type is proposed, for example, in DE 101 48 667 A1. From the location data which are obtained in this system from the reception of the position properties of a plurality of satellites, a speed vector can also be determined with a plurality of measurements at a temporal separation. DE 101 48 667 A1 also proposes placing this speed value determined by means of GPS in relation to further speed values which are obtained, for example, by means of inertial sensors, for example, by averaging.

The disadvantage of the speed determination by means of GPS in this way is significant inaccuracy. Although a location can be determined by means of GPS with an accuracy of approximately 1 or 2 m, this additionally involves multiple determination of locations at short time separations so that the inherent errors in the location determination add a plurality of times and can also in practice lie in different directions. With relatively short time separations, in order to obtain the most current possible speeds, this leads to the error rates rising significantly accordingly.

It is also proposed in EP 0 838 660 B1 that speed information made available by the GPS signal should be used and suitably combined with other data. It is not specified precisely what the speed information in the GPS signal is and how it could be processed.

Indeed, the signals emitted by the GPS satellites can contain information regarding the current speed and movement direction of the satellite itself, which could then be further processed in a form still to be determined.

From EP 1 007 391 B1, the concept is also known to provide additional measures for a use of GPS signals in aircraft, including determining and suitably isolating the errors in the signals emitted by the satellites in order to preclude erroneous determinations in air travel as completely as possible.

Since it is required to capture the speed of moving vehicles in a suitable form, using the Doppler effect also comes into consideration. This Doppler effect arises therefrom that a GPS receiver moving with the vehicle moves relative to the signal which is emitted by the GPS emitters in the satellites. If information about the speed and direction of the movement of the satellite is contained in the signals as described above, then making use of the Doppler effect, the current speed of the receiver can also be determined. This possibility is significantly more accurate than a determination of the speed by means of a pure change of location.

For this purpose, the signals received must also contain information on the corresponding speed of the satellite while it emits the signals.

With this possibility also, however, an unknown inaccuracy in the speed measurement is a significant problem. The deviations may change unnoticed by the user, and this makes the measurement values practically unusable since it cannot be determined whether a measurement value lies within particular limits.

For the current driving of a motor vehicle, these inaccuracies are less critical. For the driver, it does not matter greatly whether his motor vehicle is travelling at 100 km/h or at 97 km/h. During an acceleration or braking procedure, it is of little relevance to the driver at what speed he is currently travelling, provided this speed moves within a scope that is reasonable for him and is suitable for braking or accelerating.

This is different, however, if evaluations must be carried out from these speed values at a later time. This relates not only to the optimisation of engines and vehicles in research and development, but also to other issues. For example, the stored speeds can be used for traffic monitoring and checking and their accuracy and the size and direction of a conceivable measuring error must also be able to withstand judicial examination in an individual case.

As a further case of use, the concept has arisen in recent years, for example, of having relevant values stored in motor vehicles, in order to be able to determine retrospectively particular boundary conditions of the operation of the vehicle, for example, following an accident or another event. The conventional “tachometer disks” which commonly record, in heavy goods vehicles, whether and how fast a vehicle has been driven are very imprecise and retrospectively allow only the driving behaviour over hours or the exceeding or non-exceeding of particular limit values to be recognised. These conventional measuring methods are neither intended nor suitable regarding the question of the speed at which a heavy goods vehicle has approached a crossing. But particularly for insurance reasons, in order to determine fault after accidents, such information would be of interest since the conventional situation which relies largely on witness statements for clarification or perhaps on braking tracks on the road surface often remains unsatisfactory in disputed cases.

Sometimes, speeds are also stored in ‘black box’ systems which are also known as accident data recorders and can sometimes be linked to a video recording technology. These systems measure the speed of the vehicle, usually by means of wheel sensors, or read the data from the vehicle data bus (CAN bus) which, firstly, makes installation more difficult and, secondly, requires parameterisation and, thirdly, varies from one vehicle type to the next. With the black box systems which also determine the current speed by means of GPS, there is neither compensation for the temporal offset from the video recording, nor is the GPS speed evaluated with a second method regarding its tolerance, i.e. tested for validity. There are therefore systematic errors, general measuring inaccuracies and, ultimately, a lack of confidence in the measurement values since it is barely possible to make assertions even concerning the approximate size of a possible measuring error.

Furthermore, video recordings of this type are known, for example, from the video cameras used in police vehicles, which during pursuits, can make a recording of the vehicle ahead and its driving behaviour, and replay it later. It is herein also possible to measure the speed of the police vehicle and furthermore, by means of suitable measuring devices, also to undertake a recording of the measured speed of the vehicle ahead and to associate the speed with the image recordings made in the video recording. However, this association is very unsatisfactory in the prior art and its accuracy is restricted for systematic reasons and it is not very accurate.

Video recordings of this type require a finite time to assemble a complete image from a large number of pixels. This overall time is relatively short and, with the currently available technical means, amounts to approximately 40 milliseconds. The measurement of the speed of the police vehicle is implicitly made from the measuring method associated with the tachometer and the measurement of the speed of the vehicle ahead is made indirectly, since for this, the measurement values for the pursuing vehicle are previously required as a basis. Furthermore, a particular time span is required for these measurements and it is thus very difficult to associate particular measurement values in this context with particular images recorded with the video camera, since, with the measuring method, several processes each with finite time operations take place.

Furthermore, it can naturally also be the case that, for one of the measurements determined, measuring errors exist which cannot, however, be recognised at all since there is no basis for such recognition.

It would however be desirable if possibilities were available to provide a remedy therefor.

It is an object of the invention to provide a further possibility for measurements and the storage thereof for evaluations of vehicle speeds.

This object is achieved in a method of this type by means of the following steps:
recording satellite-aided information from the Global Positioning System (GPS) for navigation devices in the vehicle,
determining the speed of the vehicle at a particular point in time from the recorded data of the GPS,
determining the acceleration and deceleration of the vehicle at a particular point in time by means of acceleration sensors,
determining the speed of the vehicle at a particular point in time from the values of the acceleration and deceleration,
determining and evaluating the deviation of the speed determination from the data of the GPS and from the values of the acceleration, and
in the event that the deviation of the speed determination does not exceed a pre-determined, possibly also variable, tolerance threshold, associating this speed determination with the image recording made at the same point in time, otherwise rejecting or suitably identifying the determined values and images.

In the case of a device, the object for combined determination of a speed and an image recording from a moving vehicle is achieved with a device
having a video camera and a storage medium connected thereto,
having a speed measuring device which is connected to the storage medium,
having a data processing device which is connected to the storage medium and is provided in order to associate the values of the speed measured at a particular point in time with images of the stored image recordings,
having a receiving device equipped to receive satellite-aided information from the Global Positioning System (GPS) for navigation devices in the vehicle,
wherein the data processing device is provided in order to determine the speed of the vehicle at a particular point in time from the recorded data of the GPS,
having acceleration sensors for determining the acceleration and deceleration of the vehicle at a particular point in time,
wherein the data processing device is provided in order to determine the speed of the vehicle at a particular point in time from the values of the acceleration and deceleration,
wherein the data processing device is provided in order to determine and evaluate the deviation of the speed determination from the data of the GPS and from the values of the acceleration, and
in the event that the deviation of the speed determination does not exceed a pre-determined, possibly also variable, tolerance threshold, to associate this speed determination with the image recording made at the same point in time, otherwise to reject or suitably identify the determined values and images.

According to the invention, it is thus proposed to undertake an image capture by a recording by means of a video camera situated on board which records the region in front of the vehicle.

According to the invention, the speed is determined with the aid of a GPS receiver in the vehicle.

In order to be able to use a speed determined by means of GPS in a system for determining the speeds of a vehicle, it is important but now also possible according to the invention, to be able to evaluate the accuracy of said speeds in order to be able to reject the measurements where appropriate.

It is also possible to associate the speed of the vehicle measured in this way temporally, that is at a particular point in time and, for example, to insert it into the simultaneously recorded video recordings. In principle, the temporal offset would be a great problem since the displayed speeds do not necessarily match the video image. Also, due to the aforementioned finite time for the image capture, the time cannot take place at a defined point in time of the image capture. According to the invention, the image capture also takes place earlier than the determination of the GPS speed.

However, as a solution to this partial problem, according to the invention, in parallel with the determination of the speed, the acceleration in the direction of travel is also determined from the GPS receiver. A first alternative therein is to calculate, from the temporal progression of the acceleration and the information of the GPS signal, the temporal delay. A second alternative lies in determining the delay once for the GPS system and then to assume it is a constant and to use it accordingly. Through knowledge of this delay, the possibility is created of compensating for this temporal offset. For such compensation, the recorded video images can be placed in intermediate storage in a memory. This memory is then used according to the First In, First Out principle as a digital delay unit of the relevant length. For this purpose, for example, a ring memory can be used.

If the GPS speed signal is also available, for example, a few fractions of a second later, the speeds determined can then be superimposed in a timely manner in the image which has been calculated by the compensation. The image effectively contains a time stamp with a correct time and the correct speed determined for this point in time. The determination of the speed by two entirely independent routes indicates very accurately whether a possibly existing deviation is now still tolerable or not. A tolerance value can be selected for this. This tolerance value can also be selected independently of different criteria, for example, from the size of the speed or an estimated accuracy of the two individual principles. Thus, the number of satellites which have yielded the GPS signal can be taken into account, since with the number of satellites taken into account, the reliability of the location determination from the GPS data also increases, said location determination itself having been a basis of the speed determination of this one value.

These considerations will be discussed in greater detail below.

As an alternative possibility of a temporal compensation, the possibility also exists of calculating the current speed from the last applicable value for the speed according to the GPS plus the accelerations occurring up to that point according to the formula v(t)=∫(a(t))+v_{gps}, that is, by integration.

This offers the advantage, in particular, that with a sufficiently high sampling rate of the acceleration values (multiple of the image frequency) the associated speed can be calculated for each image, even if the GPS speed is not available at the appropriate (usually low) sampling rate.

The pure calculation of speed from the acceleration data by integration over a relatively large time period is not preferred since due to the integration, the speed value drifts away at a low frequency.

If the acceleration values are available at sufficient temporal resolution or if the acceleration values are available matching and approximately temporally simultaneously with the image capture, then the matching speed value can be calculated by the same method.

In order now to verify the accuracy of a speed value determined with the aid of the GPS, the acceleration can be determined from the speed values. The acceleration determined in this way is now compared with the acceleration values from the sensor. If herein a particular specified deviation is recognised or exceeded, the measurement is rejected. Measurements which are not sufficiently reliably correct are therefore recognised as such and cannot be used for erroneous assessments of a situation.

The procedure described above, specifically that the speed is calculated from the acceleration values and from GPS and is subsequently compared with further GPS speeds, can also advantageously be represented in a closed loop, as described below. The controlled variable can then be used to estimate the accuracy.

From the last known speed (delayed GPS speed) the current speed is calculated by summation of the acceleration. If a new GPS speed is now available, this is compared with the value calculated for this point in time. Depending on the deviation, the offset of the acceleration value (or the rotation angle in the rotation matrix for matching the orientation in the vehicle) is then adjusted accordingly. This generates a behaviour like a high pass with a very low limit frequency, so that the drift phenomena are eliminated. The control deviation herein gives a measure for the accuracy of the GPS speed.

In order to determine the deviation of the accuracy of the GPS speed, different parameters can also be gathered from the signal of the GPS, for example the number of satellites, from which it was possible to receive the relevant signal information. The signal-to-noise ratio can also be used.

From these parameters, conclusions can then be made concerning the accuracy of the GPS measurement. This relationship is thus empirically determined for a corresponding GPS system.

In this way, the system can ensure a maximum error in the speed measurement of 5 km/h (alternatively 3 km/h) for a measured speed of up to 100 km/h. At speeds of above 100 km/h, the maximum error would be 5% (alternatively 3%).

The acceleration sensor according to the invention is advantageously configured as a 3-axis sensor in order to be able to determine the acceleration in three coordinates. The orientation of the sensor to the vehicle is herein determined by the installation of the device in the vehicle and is usually initially unknown. Since gravity is always measured downwardly as a constant acceleration value, the orientation in the vehicle can be calculated therefrom and the acceleration in the direction of travel of the vehicle must possibly be taken into account, in accordance with its direction. If this is known, the acceleration values are converted to the vehicle coordinate system with the aid of a rotation matrix, so that apart from the acceleration in the direction of travel, the transverse acceleration and the acceleration perpendicular to the road are also obtained.

These values can also be used to determine parameters of the driving behaviour in that the acceleration values not only in the driving direction, but also perpendicular thereto are used. When travelling round curves, for example, a transverse acceleration occurs which is greater the faster the curve is travelled. In this regard, this can advantageously also be used at the same time to classify the driving behaviour (also known as “driver behaviour”). The tilt angle can also be determined for motorcycles. The values of the acceleration sensor can now also be used to determine an accident or critical driving and then to store or transmit a video sequence.

It is also possible in any event to determine the speed value for identified deviations and to display it differently or remove it in order, by this means, to make clear that the values given no longer comply with the tolerances. In this way, at least those parts of a recording which even without this information are still usable can be used.

The installation of such systems, for example, in commercial vehicles such as buses or heavy goods vehicles, but also in taxis or hire vehicles would be a very suitable measure which offers advantages not only with regard to greater accuracy, but also completely replaces existing, susceptible, unreliable systems and therefore saves costs. Through the exact determination of the speed and its association with particular video recordings, conventional tachometer disks can be replaced without difficulty since the values achievable with the invention can return significantly more detailed information.

By means of the connection of a system of this type (video recording with superimposed speed, measurement of acceleration values and the classification according to particular parameters) with a mobile radio data connection, the possibilities for transmitting and receiving are also used to transmit the data determined including the data for the video recordings by means of telecommunications to a central site, where they can be placed in existing memory stores. This also represents, in particular, protection against manipulation in the vehicle and also enables further advantageous embodiments, for example, further processing, protection against unauthorised access to the data, linking to fleet management systems by means of an API and immediate real-time access to data without the need to access the vehicle.

In this way, a possibility for counteracting theft of the whole vehicle is achieved, since following a theft, either the route taken by the unauthorised driver would be recorded on video and transmitted to a central site, which naturally simplifies the tracking accordingly, or the unauthorised vehicle driver would be forced to put the relevant system out of operation, which would also necessarily lead immediately to a corresponding alarm during this process.

But otherwise, it could also be ensured whether, for example, in hire cars the distance travelled still corresponds to the information on the tachometer, which counteracts manipulation and, in the case of accidents, the question of fault would be significantly more easily clarified retrospectively, even if only one of the vehicles involved in the accident were equipped according to the invention.

A method will now be described in greater detail making reference to a simplified exemplary embodiment.

A vehicle is equipped with a video camera and a GPS receiver. The GPS receiver contains additional functions compared with conventional navigation devices.

A location determination alone is known from conventional navigation devices. However, the GPS satellites additionally indicate in their signals their frequency and also the speed with which a satellite is currently moving through space in a particular direction. By using the Doppler effect in the moving vehicle, it can now be determined at what speed the vehicle is moving relative to this signal of the satellite. With two or, better, with three or four satellites, this Doppler effect can be used in relation to a plurality of moving satellites and thereby, the direction of the vehicle and also the speed can be determined exactly in addition to the further existing possibility of determining the speed from the location coordinates by subtraction.

However, the determination of this speed from the Doppler effect is not current, but is slightly delayed. The device must initially find the satellites, determine and measure the Doppler effects and then calculate something therefrom. For this purpose, a finite time is required.

Once the speed has been determined therefrom, it should now be “printed” onto the corresponding image of the video film, naturally in a digital electronic form. For this purpose, the also delayed image which exactly fits this speed measurement must now be found.

It is therefore the case, in a manner of speaking, that photographs are taken and then information is subsequently written on the back thereof, but all electronically of course, and where “subsequently” is approximately 1 second later.

The possibility exists that the acceleration in the direction of travel is also recorded at any time and from the temporal course thereof, it is determined at which point in time which speed of the vehicle was current and that this is then associated with the relevant image.

All of the recordings with the data are naturally not contained in the device in the vehicle, but are preferably sent directly with UMTS to a server. In the case of a taxi operator or a hire care control centre or even a haulage operator with a plurality of heavy goods vehicles, this server can be located in the control centre. The control centre then knows at all times which vehicle is where, how it is currently moving, whether it is stationary, etc. It can also be ascertained whether the driver is the one who is currently authorised to drive this vehicle.

Vehicles equipped according to the invention which are involved, for example, in traffic accidents offer to the insurance companies against whom claims are made in such a case, for example, by parties to an accident, a very much better and more precise possibility either for rebutting such claims by the parties as unjustified or of preventing in advance unnecessary legal disputes. This can have the result that the insurance companies grant to their suitably equipped insured parties a bonus or a reduced premium if they suitably equip their motor vehicles. In this way, the motor vehicle keepers would also benefit from an advantage which in some cases offsets the costs of equipping the vehicle with the components according to the invention.

1. Method for the combined determination of a speed and an image recording from a moving vehicle, comprising the following steps:
recording an image of a region in front of the vehicle by means of a video camera and storing it in a storage medium,
measuring the speed of the vehicle and storing it in a storage medium,
associating the values of the speed recorded at a particular point in time with images of the stored image recordings,
characterised by the following steps:
recording satellite-aided information from the Global Positioning System (GPS) for navigation devices in the vehicle,
determining the speed of the vehicle at a particular point in time from the recorded data of the GPS,
determining the acceleration and deceleration of the vehicle at a particular point in time by means of acceleration sensors,
determining the speed of the vehicle at a particular point in time from the values of the acceleration and deceleration,
determining and evaluating the deviation of the speed determination from the data of the GPS and from the values of the acceleration, and
in the event that the deviation of the speed determination does not exceed a pre-determined, possibly also variable, tolerance threshold, associating this speed determination with the image recording made at the same point in time, otherwise rejecting or suitably identifying the determined values and images.

2. Method according to claim 1,
characterised in that,
in determination of the speed of the vehicle at a particular point in time from the recorded data of the GPS, the data concerning the Doppler effect are used.

3. Method according to claim 1 or 2,
characterised in that,
a connection to a mobile radio network is provided, and that the data determined including the image recordings are transferred by means of telecommunications to a central site.

4. Method according to one of the preceding claims,
characterised in that,
the current speed results, by integration, from the last applicable value for the speed determined from the data according to the GPS plus the accelerations occurring up to the current point in time according to the formula v(t)=∫(a(t))+v_{gps}.

5. Device for the combined determination of a speed and an image recording from a moving vehicle, with a method according to any of the preceding claims,
having a video camera and a storage medium connected thereto,
having a speed measuring device which is connected to the storage medium,
having a data processing device which is connected to the storage medium and is provided in order to associate the values of the speed measured at a particular point in time with images of the stored image recordings,
having a receiving device equipped to receive satellite-aided information from the Global Positioning System (GPS) for navigation devices in the vehicle,
wherein the data processing device is provided in order to determine the speed of the vehicle at a particular point in time from the recorded data of the GPS,
having acceleration sensors for determining the acceleration and deceleration of the vehicle at a particular point in time,
wherein the data processing device is provided in order to determine the speed of the vehicle at a particular point in time from the values of the acceleration and deceleration,
wherein the data processing device is provided in order to determine and evaluate the deviation of the speed determination from the data of the GPS and from the values of the acceleration, and
in the event that the deviation of the speed determination does not exceed a pre-determined, possibly also variable, tolerance threshold, to associate this speed determination with the image recording made at the same point in time, otherwise to reject or suitably identify the determined values and images.

6. Device according to claim 5,
characterised in that,
a three-axis sensor is used as the acceleration sensor.
